(19) United States
(12) Patent Application Publication
(10) Pub. No.: US 2013/0157223 A1
(43) Pub. Date: Jun. 20, 2013

(54) IMPLANT DENTAIRE

(71) Applicant: Sudimplant, Toulouse (FR)

(72) Inventor: Olivier BENHAMOU, Bruxelles (BE)

(73) Assignee: SUDIMPLANT, Toulouse (FR)

(21) Appl. No.: 13/660,180

(22) Filed: Oct. 25, 2012

(30) Foreign Application Priority Data
Oct. 25, 2011 (EP) 11290519.5

(51) Int. Cl. A61C 8/00

(52) U.S. Cl. CPC A61C 8/0037
USPC 433/174; 433/173; 29/896.1

(57) ABSTRACT

Dental implant having an internal geometry and an external geometry, the external geometry comprising at least three sections. This dental implant is provided with a fixing means implemented by a fixing of the Morse cone type in order to fix thereon a prosthetic stud and comprises an ovoid shaped cervical section or a ceramic ring.

### FIELD OF THE INVENTION

The present invention relates to a dental implant having an internal geometry and an external geometry, said external geometry comprising at least three sections, one of which forms the cervical section, said implant being provided with a fixing means arranged to fix a prosthetic stud therein.

### PRIOR ART

Generally, such implants are used in dentistry. A dental implant is an artificial root, the role of which is to replace a natural tooth root. The surgical fitting thereof consists of producing, by drilling in the jaw bone, an alveolus (drilling well) in which the dental implant will be screwed or impacted. Following the placing of the dental implant and after a healing time, a prosthetic component will be fixed thereto and will support a crown or a dental appliance.

For many years, the bioforms and surface states of dental implants have changed in order to result in better biocompatibility and osteointegration. Initially, dental implants were made from titanium, without any surface treatment, and had to be impacted in the jaw bone. In order to be less traumatic for the bone, dental implants were then provided with threads in order no longer to impact them but indeed to screw them into the jawbone. In addition, the titanium surfaces of the implants were gradually modified, by various physical and chemical treatments, in order to optimize the osteointegration thereof.

Dental implants subsequently had essentially cylindrical shapes in order to fill in the space left vacant by the loss of a tooth but also to have a larger surface of contact with the bone. More recently, studies revealed that an anatomical shape approaching that of the natural tooth roots was to be preferred, and thus conical implants have been developed. However clinicians have perceived that the crestal bone, situated at the top of the jawbone and in contact with the gum, sometimes reabsorbed, giving rise to periodontal problems the management of which is still tricky (craterisation). This is why micro-threads situated solely in the cervical part of dental implants have been developed, thus assisting the preservation of the crestal bone.

The prosthetic elements may be fixed to the implant in many ways: screwed, trans-screwed, which means that the prosthetic element is pierced at its center in order to receive a screw therein, or by friction, in particular a fixing of the Morse cone type. At the present time, the fixing system of the Morse cone type has proved its worth and offers the advantage of providing a durable prosthetic fixing to the implant and a better seal between the implant and the gum.

The choice of the fixing system will determine the bioform of the implant since the fixing system will have a certain space requirement at the implant, in particular with the fixing system of the Morse cone type. Despite this bulky fixing system, it is necessary to leave a sufficient thickness of material (titanium, ceramic, polymer, etc.) in order not to weaken the mechanical strength of the implants, which must be in close contact with the surrounding bone. This has repercussions on the bioform of the implant, in particular in the cervical part thereof, where a minimum diameter is to be complied with.

Currently there exist various types of dental implant with various profiles, such as for example implants in the form of a blade or disc, needle implants, juxta-bone implants, cylindrical or cylindro-conical implants etc. However, such dental implants pose problems because of their shapes and geometries. This is because the majority of current dental implants do not sufficiently respect the biological tissues, which may cause infections, a process of rejection, or even bone dissolution, or procure unpleasant sensations and/or non-integration of the implant in the bone.

### BRIEF SUMMARY OF THE INVENTION

The aim of the present invention is to produce a dental implant that better respects the biological tissues while affording better integration of the implant, in particular in the crestal region, without disorganizing the bone cells.

A dental implant according to the present invention is characterized in that the external geometry of the dental implant comprises a cervical section of ovoid shape in the longitudinal direction and a fixing means implemented by a fixing of the Morse cone type for fixing the prosthetic stud. A dental implant with an ovoido-cylindro-conical shape combined with a fixing means of the Morse cone type affords optimum primary anchoring in the bone, a maximum surface of contact with the surrounding bone, and better absorption of the bone compression by the ovoid section (release of stresses related to the insertion of the implant in the bone), without disorganizing the bone cells and while respecting the biological tissues. This ovoid shape of the implant, associated with the emergence shape of the stud given by the Morse cone, will provide a healthy biological space around the implant.

A particular embodiment of the present invention concerns a single-piece dental implant made from titanium or zirconia-titanium, having an internal geometry comprising at least three sections in order to provide good ergonomics as well as good prosthetic security and an external geometry comprising at least three sections in order to provide good anchoring in the jawbone.

The external geometry comprises a cervical section with ovoid shape having a diameter that decreases towards the head of the dental implant. This cervical section may be surmounted by a beveled part or by a ceramic ring encircling a titanium cylinder that forms part of the body of the implant and is connected to the cervical section of the implant by an intermediate so-called collar section. The beveled part makes it possible to join, in a non-traumatic fashion for the crestal bone, the emergence of the prosthetic stud. The ceramic ring provides both a perfect seal for the implant, making it possible to avoid any bacterial infiltration at the crestal bone, and better healing of the surrounding soft tissues.

Under this ovoid-shaped cervical section, there preferably succeed each other, in a descending direction, a section with a cylindrical shape, a section with a conical shape and a section with a point shape. The section with a point shape and the section with a conical shape comprise a conical spiral at their surface, enabling the dental implant to be self-tapping and thus to bite into the surrounding bone in order to ensure the fixing of the dental implant. The self-tapping conical spiral facilitates the screwing of the dental implant into the bone and provides better fixing of the dental implant, which will bite directly in the surrounding bone.

The internal geometry comprises, in a descending direction, a Morse cone (fixing of the prosthetic piece), an alignment cone (guidance for insertion of the ancillaries and prosthetic pieces), a hexagonal polygon (enables the dental implant to be fitted and ensures non-rotation of the prosthesis), a groove (for gripping the implant) and a tapping (which will receive the fixing screw of the prosthetic piece.

### BRIEF DESCRIPTION OF THE FIGURES

FIG. 1 is a schematic illustration of the sections that make up the external geometry of a dental implant according to a first embodiment according to the invention.

FIG. 2 is a schematic illustration of the sections that make up the external geometry of a dental implant according to another embodiment according to the invention.

FIG. 3 is a schematic illustration of the sections that make up the external geometry of a dental implant according to yet another embodiment according to the invention.

FIG. 4 is a schematic illustration of the sections that make up the internal geometry of a dental implant according to the invention.

FIG. 5 is a schematic illustration of the top part of the dental implant, the cervical part of which is surmounted by a ceramic ring according to the invention.

### DESCRIPTION OF THE INVENTION

The invention will now be explained in more detail with reference to the accompanying figures. In the drawings, the same reference is attributed to the same element or to a similar element.

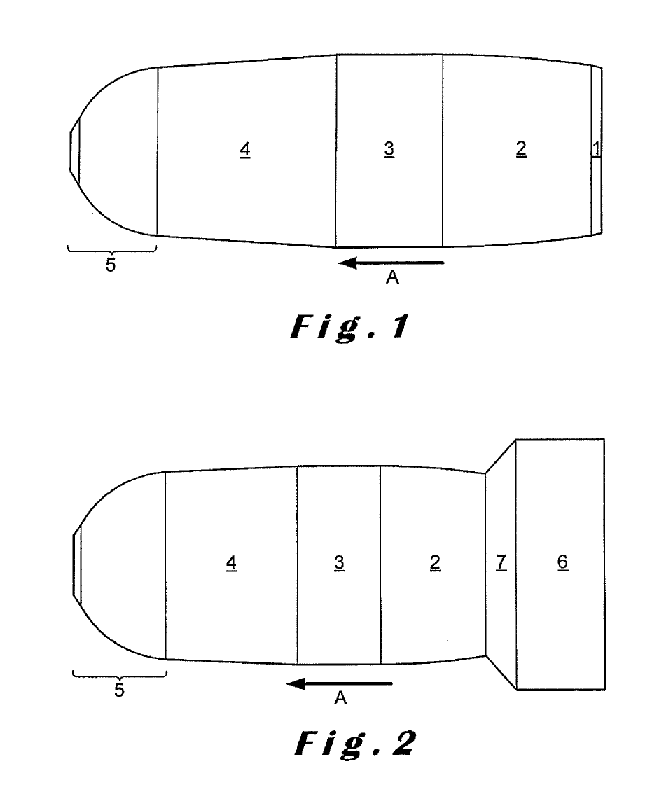

As illustrated in FIG. 1, the external geometry of the dental implant comprises an ovoid-shaped cervical section (2) the length of which is between 1.0 and 4.0 mm and the diameter of which decreases towards the head (situated to the right in the figure) of the dental implant by 2% to 10%. This cervical section (2) may be surmounted by a beveled neck (1) with a length of between 0.1 and 0.5 mm and the bevel of which makes it possible to join, in a non-traumatic fashion for the crestal bone, the emergence of the prosthetic stud.

Preferably, the external geometry of the dental implant comprises, under the ovoid-shaped cervical section and in a descending direction indicated by the arrow A with respect to the direction in which the implant is implanted:

a) a cylindrical-shaped section (3) the length of which is between 1.0 and 7.0 mm according to the total length of the implant. The cylindrical part (3) enables the dental implant to have a maximum amount of contact with the surrounding bone when it is implanted in order thus to afford good anchoring in the bone;

b) a conical-shaped section (4) the length of which is between 2.0 and 6.0 mm. This conical section (4) provides the anchoring of the dental implant in the jawbone. The conicity of the conical part (4) of the dental implant has an anatomical profile similar to that of a natural tooth and improves the anchoring of the dental implant in the jawbone. This anchoring is reinforced by the presence of threads (shown in FIG. 4) on said conical section (4);

c) a section in the form of a point (5) the length of which is between 0.05 and 1.0 mm and which is conical between 40° and 70°. This section in the form of a point (5) serves as a guide and facilitates the insertion of the dental implant in the drilling well (the bone housing).

According to another embodiment illustrated in FIG. 2, said external geometry of said dental implant comprises a ceramic ring (6) that surrounds a titanium cylinder (13, shown in FIG. 5), said titanium cylinder (13) forming part of the body of the implant and being connected to the ovoid section (2) of the implant by an intermediate section referred to as the collar (7). The assembly consisting of ceramic ring (6) and collar (7) has a length of between 1.0 and 5.0 mm and a diameter of between 3.0 and 7.0 mm.

The ceramic ring (6) ensures both a perfect seal of the implant with the gum, preventing any bacterial infiltration at the crestal bone, and better healing of the surrounding soft tissues.

Preferably, the external geometry of said dental implant comprises, in a descending direction with respect to the direction (arrow A) in which the implant is implanted and under said ceramic ring (6) and said collar (7):

a) an ovoid shaped cervical section (2) the length of which is between 1.0 and 4.0 mm and the diameter of which decreases towards the head of the dental implant by 2% to 10%;

b) a cylindrical shaped section (3) the length of which is between 1.0 and 7.0 mm according to the total length of the implant. Said cylindrical part (3) enables said dental implant to have a maximum amount of contact with the surrounding bone when it is implanted;

c) a conical-shaped section (4) the length of which is between 2.0 and 6.0 mm. This conical section (4) provides the anchoring of the dental implant. The conicity of the conical part (4) of the dental implant has an anatomical profile similar to that of a natural tooth and improves the anchoring of the dental implant in the jawbone. This anchoring is reinforced by the presence of threads (shown in FIG. 4) on said conical section (4);

d) a section in the form of a point (5) the length of which is between 0.05 and 1.0 mm and which is conical between 40° and 70°. This section in the form of a point (5) serves as a guide and facilitates the insertion of the dental implant in the drilling well.

The ceramic ring (6) surrounds a titanium cylinder (13) that forms part of the body of the implant and is connected to the ovoid section (2) of the implant by an intermediate section referred to as the collar (7). Said ceramic ring (6) is fixed to said titanium cylinder (13) for example by banding, force-fitting, adhesive bonding, welding, brazing, or any mechanical or chemical fixing means, so that the ceramic ring and the body of the implant constitute the same piece (single-piece implant). The external profile of the ceramic ring (6) may be straight or angular, depending on the prosthetically usable space.

Said implant also comprises on its external face a self-tapping part over a length of between 3.0 and 5.0 mm and which is formed by a conical spiral. This conical spiral is characterized by a pitch of between 10.0 and 25.0 mm over all the sections of the external geometry with exception of the cervical section (2) and the cylindrical section (3). Said self-tapping part, cruciform at its end, helically scores the section in the form of a point and the conical shaped section of the external geometry of the dental implant with a square profile in a plane normal to the axis, at values of between 0.1 and 0.4 mm according to the diameters of the axis of revolution in the two directions of the plane. Once said dental implant is in place, said self-tapping part acts as an anti-rotational device, creating a cavity in the bone in which the bone can re-form and thus block any rotation of said dental implant in its alveolus (drilling well) during maneuvers of screwing and unscrewing the prosthetic element.

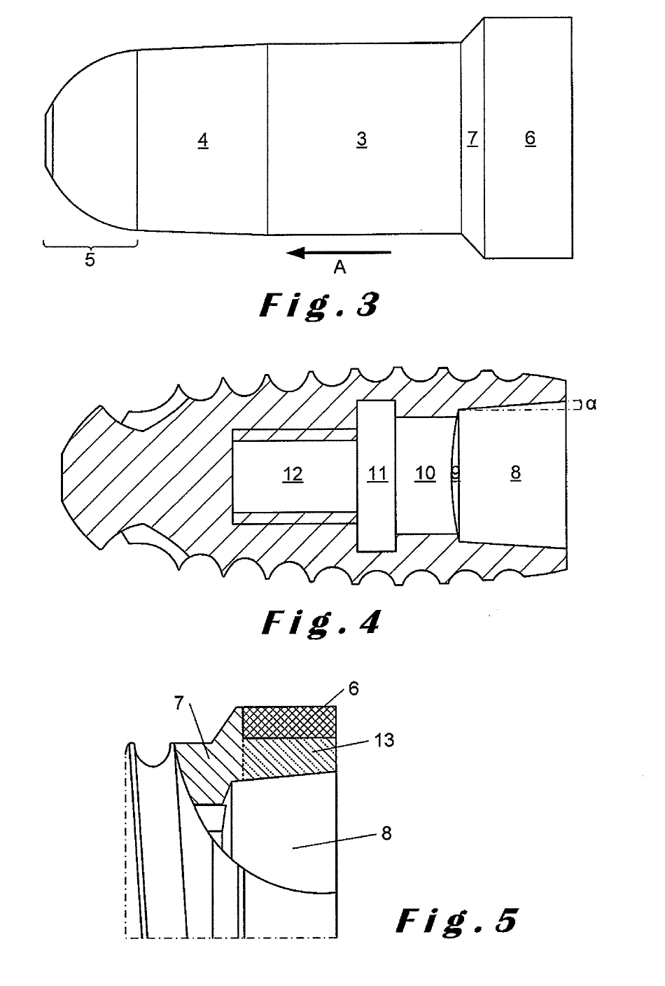

According to an alternative embodiment illustrated in FIG. 3, the external geometry of the dental implant comprises, in a descending direction, the same elements as those mentioned in the embodiment set out in FIG. 2 with the exception of the ovoid shaped cervical section.

The present invention concerns more particularly a dental implant having an internal geometry comprising at least three sections and an external geometry comprising at least three sections.

Said internal geometry of said dental implant, according to the present invention and illustrated in FIG. 4, comprises, in a descending direction with respect to the direction in which the implant is implanted:

a) a Morse cone (8) the angulation of which is between 2.0° and 9.0° and the length of which is between 1.0 and 2.5 mm. This Morse cone (8) provides the fixing and durable holding of the prosthetic stud (not shown in the drawing) in the implant in the desired position. Said Morse cone (8) offers a large contact surface despite the small angle of the cone (angle α in FIG. 4) in order to provide a maximum embedding effect, while allowing a repositioning before the screwing of the Morse cone in the implant. Preferentially, the connection with the prosthetic stud provided by said Morse cone (8) will be activated at the time of the fitting of the prosthetic element trans-screwed by means of a calibrated torque wrench (20 to 30 N.cm) or a motorized handpiece indicating the torque;

b) a 120° alignment cone (9) that enables the practitioner to place the prosthetic stud in the required position before any locking;

c) a hexagonal polygon (10) the length of which is between 0.8 and 1.2 mm. This hexagonal polygon (10) enables the dental implant to be positioned by means of a chuck and the indexing (the choice of the position) of the prosthetic stud. In addition it confers an anti-rotational role on the prosthesis;

d) a groove (11) the length of which is between 0.5 and 0.8 mm and enabling this implant to be gripped by a chuck provided with a ring that will be housed in this groove;

e) a thread (12) over a height of between 1.5 and 3.0 mm and which allows trans-screwing or screwing, according to the prosthetic element used.

Preferentially, according to the present invention, the length of said dental implant is between 6.0 and 17.0 mm while the diameter of said dental implant is between 2.5 and 7.0 mm.

The present invention also relates to a method of manufacturing a dental implant from a longitudinal part that will be fashioned so that the external geometry of the dental implant comprises, in a descending direction from the head of the dental implant, a bevel, an ovoid shaped cervical section (2), a cylindrical shaped section (3), a conical shaped section (4) and a section in the form of a point (5).

Said manufacturing method comprises, following the fashioning of the section of the external geometry, a whirling step so that the surface of the external geometry of the dental implant is provided with an external thread designed in the form of a point between 30° and 40°, symmetrical on a vertical axis, with a radiate and tangent end with a radius of between 0.2 and 0.5 mm and with pitches of between 0.75 mm and 2.0 mm. Said thread pitch thus obtained is highly penetrating, self-tapping and strong through the absence of angles that generate cracks in the dental implant. Said thread pitch thus obtained, when it is implanted, assists the accumulation of a large volume of bone between two successive teeth of the thread, which has the effect of reducing the average force applied to the bone and distributing the pressure exerted on the bone.

Said manufacturing method also comprises a step of treatment of the surface of said dental implant, which is sanded with corundum, with the exception of the beveled part or the titanium cylinder and the ceramic ring, and passivated with acid, for example hydrofluoric acid. The purpose of this surface treatment is to improve the osteo-integration of said dental implant by offering a rough surface (macro- and micro-roughnesses) on which the bone will be able to fix. The surface of the beveled part is not treated by sanding in order to avoid any bacterial colonization and thus preserve the crestal bone.

1. Dental implant having an internal geometry and an external geometry, said external geometry comprising at least three sections, one of which forms the cervical section, said implant being provided with a fixing means arranged so as to fix therein a prosthetic stud, characterized in that said cervical section is ovoid in shape in the longitudinal direction and said fixing means is implemented by a fixing of the Morse cone type.

2. Dental implant according to claim 1, characterized in that said ovoid shaped cervical section has a diameter decreasing in a direction towards the head of said dental implant.

3. Dental implant according to claim 1, characterized in that said cervical section is surmounted by a beveled part, the length of which is between 0.1 and 0.5 mm.

4. Dental implant according to claim 3, characterized in that said external geometry of the dental implant comprises, in a descending direction:
a) the ovoid shaped cervical section the length of which is between 1.0 and 4.0 mm;
b) a cylindrical shaped section the length of which is between 1.0 and 7.0 mm;
c) a conical-shaped section the length of which is between 2.0 and 6.0 mm;
d) a section in the form of a point the length of which is between 0.05 and 1.0 mm.

5. Dental implant according to claim 4, characterized in that, above the cervical section, there is a ceramic ring connected to the body of the implant by banding, force-fitting, adhesive bonding, welding, brazing, or by any mechanical or chemical fixing means.

6. Dental implant according to claim 5, characterized in that said ring has a length of between 1.0 and 5.0 mm and a diameter of between 3.0 and 7.0 mm.

7. Dental implant according to claim 4, characterized in that the conical section is provided with a thread having a conicity at the thread bottom of between 4.0 and 8.0 mm.

8. Dental implant according to claim 1, characterized in that said dental implant comprises a self-tapping part with a length of between 3.0 and 5.0 mm and also comprises a conical spiral with a pitch of between 10.0 and 25.0 mm over all the sections of the external geometry.

9. Dental implant having an external geometry, characterized in that said external geometry of the dental implant comprises, in a descending direction:
a) a ceramic ring having a length of between 1.0 and 5.0 mm and a diameter between 3.0 and 7.0 mm;
b) a section with a cylindrical shape the length of which is between 1.0 and 7.0 mm;
c) a section with a conical shape the length of which is between 2.0 and 6.0 mm;
d) a section in the form of a point the length of which is between 0.05 and 1.0 mm.

10. Dental implant according to claim 1, characterized in that said internal geometry comprises, in a descending direction:
a) a Morse cone the angulation of which is between 2.0° and 9.0°, and the length of which is between 1.0 and 2.5 mm;
b) an alignment cone at 120°;
c) a hexagonal polygon the length of which is between 0.8 and 1.2 mm;
d) a groove the length of which is between 0.5 and 0.8 mm;
e) a thread over a height of between 1.5 and 3.0 mm.

11. Dental implant according to claim 5, characterized in that the total length of said dental implant is between 6.0 and 17.0 mm and in that the diameter measured at the cervical section of said dental implant is between 2.5 and 7.0 mm.

12. Method of manufacturing a dental implant according to claim 1, characterized in that said external geometry is machined by whirling so that it is provided on its surface with an external screw pitch in a point between 30° and 40°, symmetrical on a vertical axis, with a radiate and tangent end, with a radius of between 0.2 and 0.5 mm, and with a pitch of between 0.75 and 2.0 mm.

13. Method of manufacturing a dental implant according to claim 11, characterized in that said dental implant is sanded over the whole of its external geometry with the exception of the beveled part or the titanium cylinder and the ceramic ring and in that said dental implant is passivated with acid.
